(19) United States
(12) Patent Application Publication
(10) Pub. No.: US 2023/0008507 A1
(43) Pub. Date: Jan. 12, 2023

(54) SYSTEMS AND METHODS FOR MULTI-FACTOR SOLUTION OPTIMIZATION

(71) Applicant: Verizon Patent and Licensing Inc., Basking Ridge, NJ (US)

(72) Inventors: Tommaso Bianconcini, Florence (IT); David Di Lorenzo, Florence (IT); Lorenzo Moschi, Firenze (IT); Marco Gualtieri, Firenze (IT); Paolo Raiconi, Florence (IT); Alessio Frusciante, Firenze (IT); Luca Bravi, Florence (IT); Alessio Anzivino, Pistoia (IT)

(73) Assignee: Verizon Patent and Licensing Inc., Basking Ridge, NJ (US)

(21) Appl. No.: 17/372,908

(22) Filed: Jul. 12, 2021

(51) Int. Cl. G06N 3/00; G01C 21/34

(52) U.S. Cl. CPC G06N 3/006; G01C 21/3453

(57) ABSTRACT

A system described herein may provide a technique for the identification of solutions, such as routing solutions based on a starting point and a destination, based on Key Performance Indicators (“KPIs”) associated with models that are included in, or are associated with, candidate solutions. A solution request may specify a set of KPI preferences, based on which certain KPIs may be more heavily weighted than others in the identification of a suitable solution. Multiple solutions may be identified, with measures of comparative differences or similarities identified. A requestor may be able to make an informed decision between multiple candidate solutions based on the identification of the comparative differences.

### BACKGROUND

Navigation systems, routing systems, or other systems may attempt to optimize processes, paths, routes, etc. based on a particular set of Key Performance Indicators (“KPIs”) in order to provide solutions with optimal scores, costs, etc. Such scores, costs, etc. may be measured or reflected in terms of the particular set of KPIs. One such example includes navigation systems that provide optimal routes based on KPIs that may include the fastest travel time, the shortest distance, or other KPIs.

### BRIEF DESCRIPTION OF THE DRAWINGS

FIG. 1 illustrates an example overview of one or more embodiments described herein;

FIG. 2 illustrates an example set of models that may be generated based on a received set of KPIs, in accordance with some embodiments;

FIG. 3 illustrates an example of a set of road segments associated with a road;

FIGS. 4 and 5 illustrate an example selection of one or more solutions that may be selected based on a ranking and/or filtering process of some embodiments;

FIGS. 6 and 7 illustrate an example of the ranking and/or filtering process of some embodiments;

FIG. 8 illustrates an example of identifying relative characteristics of solutions in accordance with some embodiments;

FIG. 9 illustrates an example process for generating a solution in response to a solution request, in accordance with some embodiments;

FIG. 10 illustrates an example environment in which one or more embodiments, described herein, may be implemented;

FIG. 11 illustrates an example arrangement of a radio access network (“RAN”), in accordance with some embodiments; and

FIG. 12 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for the dynamic identification of solutions, such as routes, paths, or the like, that are optimized based on one or more Key Performance Indicator (“KPI”) preferences, weights, constraints, etc. associated with a given solution request. As one example, a “solution” may refer to a set of routes, paths, etc. along a set of roadways that are provided in response to a navigation request, such as a request to provide navigation instructions from a starting point to a destination. In such an example, the solution may include an identification of one or more roads, road segments, intersections, and/or other road features to traverse in order to reach the destination from the starting point. Different requests may be associated with different KPI preferences, weights, constraints, etc. For example, one request may specify a preference for a route optimized for a first KPI (e.g., a route with the lowest possible fuel consumption), another request may specify a preference for a route optimized for a second KPI (e.g., a route with the shortest possible travel time), while yet another request may specify a preference for a route that optimizes a blend of the first and second KPIs. Furthermore, it may be desirable to dynamically alter some routes to suit a particular KPI, for example when a new point, or “stop” is added to the route, e.g., a new stop for a schedule of a series of maintenance jobs, delivery jobs, or the like.

As another example, a “solution” may refer to a set of routes, paths, etc. along a set of network devices from a first device (e.g., a User Equipment (“UE”), such as a mobile phone, a laptop computer, etc.) to a second device (e.g., a web resource, a content server, etc.). In accordance with some embodiments, different solutions may be identified according to differing sets of preferences, weights, constraints, etc. such as a preference to optimize KPIs such as latency, error rate, throughput, and/or other types of performance metrics. In practice, embodiments described herein may be used to determine other types of solutions in other types of systems, where such solutions are optimized and/or selected based on differing sets of preferences, weights, constraints, etc.

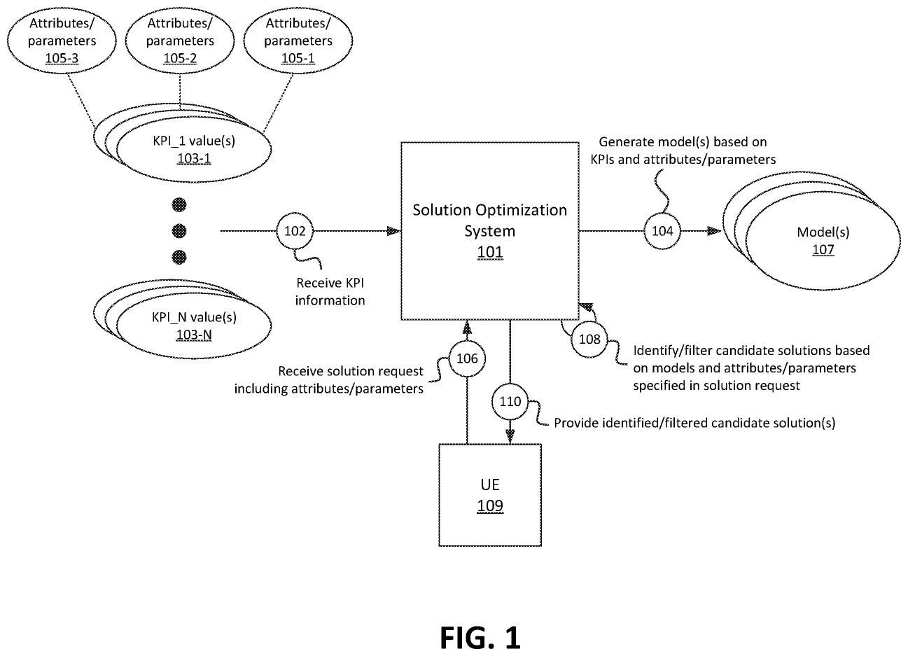

For example, as shown in FIG. 1, Solution Optimization System (“SOS”) 101 may receive (at 102) a set of KPI information. The KPI information may be associated with one or more devices or systems, and may include measured values, predicted values, simulated values, etc. that indicate performance, attributes, or other metrics associated with the devices or systems. The KPI information may include one or more values for one or more different KPIs, such as a set of KPI values 103-1 associated with a first KPI, and one or more other sets of KPI values 103-N associated with another KPI. For example, in the context of a navigation system, the first set of KPI values 103-1 may include values reflecting a set of travel times, another set of KPI values 103-2 may include values reflecting a set of fuel consumption metrics, another set of KPI values 103-3 may include values reflecting a measure of vehicular emissions, etc. In the context of a network routing system, the first set of KPI values 103-1 may include latency values, a second set of KPI values 103-2 may include throughput values, etc.

As further shown, each particular KPI value 103 may be associated with a respective set of attributes and/or parameters 105. Attributes and/or parameters 105 may include attributes, characteristics, etc. based on which particular KPI values 103 may be grouped, clustered, etc. For example, in the context of a navigation system, attributes and/or parameters 105-1, associated with a particular KPI value 103, may include location information, time information (e.g., a time or times corresponding to when such KPI values 103 were measured or determined), vehicle information, an identifier of a road or road segment with which the KPI value is associated, or the like.

For example, a UE that is located within a vehicle may measure KPI information and may report the KPI information to SOS 101 via an application, an application programming interface (“API”), or the like. The UE may provide KPI values 103, such as vehicle speed and/or velocity, as well as attributes and/or parameters 105, such as a location or locations at which the speed and/or velocity was measured, a make and/or model of the vehicle in which the UE is located, a time at which the speed and/or velocity was measured, etc. As another example, a telematics system integrated in the vehicle may measure and/or report the speed and/or velocity, as well as attributes and/or parameters 105 associated with the speed and/or velocity. The telematics system of the vehicle may determine and report other types of KPI values 103, such as fuel consumption, vehicular emissions (e.g., carbon monoxide, sulfur oxides, nitrogen oxides, etc.), and/or other types of KPI values. Similarly, the telematics system may determine and report attributes and/or parameters 105 associated with such KPI values 103. In some embodiments, one or more other sources may determine or measure KPI values 103 and/or attributes and/or parameters 105. In some embodiments, KPI values 103 and/or attributes and/or parameters 105 may be determined based on one or more simulations, in addition to or in lieu of real-world measurements of KPIs.

SOS 101 may generate and/or refine (at 104) one or more models 107 based on the received KPI information. For example, SOS 101 may cluster KPI values 103 based on matching attributes and/or parameters 105 associated with different KPI values 103. For example, a particular set of KPI values 103 may include speed information for vehicles traveling along the same road segment (e.g., as indicated by attributes and/or parameters 105 associated with KPI values 103). In some embodiments, one or more models 107 may be associated with the particular road segment, and may be based on the KPI values 103 that include the speed information for vehicles traveling along the particular road segment. As another example, one or more models 107 may be associated with a particular recurring time period (e.g., time of day, day of week, etc.), a particular vehicle type (e.g., make or model of vehicle, type of vehicle such as car or truck, etc.), and/or other attributes and/or parameters 105.

In some embodiments, SOS 101 may generate composite models that are based on one or more models 107, and/or may identify relationships or affinities between different models 107. For example, SOS 101 may generate a first set of models 107 that indicate speed information (e.g., average speed, median speed, etc.) for a particular road segment, a second set of models 107 that indicate speed information for a particular time of day, and a composite model (e.g., based on the first and second sets of models 107) that models vehicle speed on the particular road segment during the particular time of day. As another example, SOS 101 may generate a set of models 107 that indicate other KPI values 103 clustered by one or more attributes and/or parameters 105, such as vehicular emissions information, travel duration along a particular road segment, etc.

The receiving (at 102) of KPI information and the generating or modifying (at 104) models 107 may be performed as an iterative and/or ongoing process. In some embodiments, SOS 101 may utilize artificial intelligence/machine learning (“AI/ML”) techniques or other suitable techniques to generate and/or modify (at 104) one or more models 107.

As further shown, SOS 101 may receive (at 106) a solution request, including a set of attributes and/or parameters, from UE 109. For example, the solution request may include or may be associated with a navigation request from a starting point to a destination. The solution request may include attributes and/or parameters, such as vehicle information, a time associated with the navigation request (e.g., a time at which travel based on the navigation request is expected to begin), and/or one or more KPI preferences, weights, constraints, etc. (herein referred to as “KPI preferences” for brevity). The KPI preferences may include an indication of KPIs to optimize when determining a solution based on the solution request, minimum or maximum threshold values for particular KPIs, a ratio or proportion of different KPIs to optimize (e.g., 60% vehicular emissions and 40% travel time), and/or other types of KPI preferences.

For example, a user of UE 109 may manually select one or more KPIs to prioritize or optimize, such as a user who has a greater desire to minimize vehicular emissions than to minimize travel time for a given navigation route. As another example, SOS 101 may automatically determine KPI preferences for the request based on user information associated with UE 109 and/or other factors (e.g., a user of UE 109 may not need to manually indicate KPI preferences). In some embodiments, SOS 101 may identify KPI preferences based on one or more other factors. As such, different solution requests (e.g., requests from different UEs 109, requests received at different times of the day, requests associated with different vehicle types, etc.) may be associated with different sets of KPI preferences.

SOS 101 may identify (at 108) a group of candidate solutions based on the request. For example, in the context of a navigation system, SOS 101 may identify a set of routes (e.g., which may include roads, road segments, intersections, turns, and/or other navigation-related actions) that reach the specified destination from the specified starting point. In some embodiments, SOS 101 may filter, rank, and/or otherwise select (at 108) one or more of the candidate solutions based on the KPI preferences indicated in the solution request.

For example, as discussed below, SOS 101 may identify one or more models 107 associated with the candidate solutions, where such models 107 may indicate predicted or modeled KPI information associated with the candidate solutions. SOS 101 may further determine which solutions are associated with KPIs that meet the KPI preferences indicated in the solution request. For instance, if the KPI preferences indicate a relatively high weight or preference for reduced vehicular emissions and a relatively low weight or preference for reduced travel time, SOS 101 may identify one or more solutions that provide for relatively vehicular emissions, even if such identified solutions are associated with a longer travel time than other solutions. In identifying candidate solutions that meet the KPI preferences specified in the solution request, SOS 101 may also filter out candidate solutions that fall outside of one or more thresholds specific by the KPI parameters (e.g., a maximum measure of vehicular emissions, a maximum travel time, etc.), and/or may filter out candidate solutions that are a less optimal balance of one or more KPIs specified in the KPI preferences than other candidate solutions. In some embodiments, SOS 101 may score candidate solutions based on weights associated with multiple KPIs (e.g., as indicated in the KPI preferences), and may rank the candidate solutions based on the scores.

SOS 101 may further provide (at 110) the identified and filtered candidate solutions to UE 109. For example, SOS 101 may provide one or more of the identified solutions as a ranked list, which may be ranked based on KPIs associated with the solutions, weighted based on the KPI preferences associated with UE 109. Additionally, or alternatively, SOS 101 may select a particular solution (e.g., a highest scoring solution, and/or some other solution) and provide (at 110) the selected solution to UE 109. In some embodiments, SOS 101 may provide different candidate solutions with an indication of how closely such solutions match the KPI preferences included in the solution request. In this manner, a user of UE 109 may be able to make an informed decision as to which solution to ultimately select, in order to satisfy considerations related to the KPI preferences indicated in the solution request.

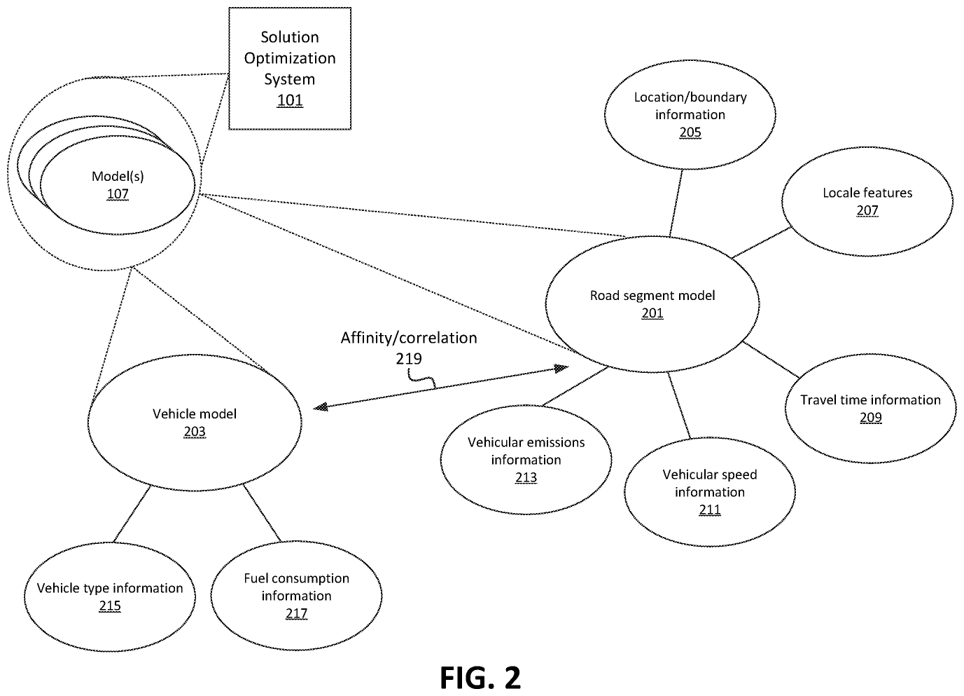

FIG. 2 illustrates example models 107 that may be generated or modified (e.g., at 104) by SOS 101 based on received KPI information, and/or which may be used (e.g., at 108) by SOS 101 to identify a set of solutions based on a solution request that specifies KPI preferences. For example, as shown, models 107 may include one or more different types of models, such as road segment model 201 and vehicle model 203. In practice, models 107 may include different types of models based on different types of KPIs. For example, while models 107 are shown as including one or more road segment models 201 and/or vehicle models 203 (e.g., which may be used in a navigation system or another type of system utilizing similar information), in practice, models 107 may include models relating to network topology (e.g., based on KPIs and/or attributes related to network performance or topology) and/or other types of suitable systems.

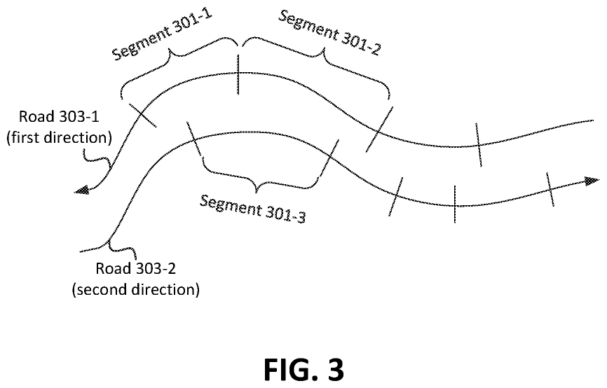

As shown, for example, road segment model 201 may include and/or may be based on KPIs and/or attributes of a particular road segment. FIG. 3 illustrates an example of road segments 301 of one or more roads 303. For example, a particular road 303 may include one or more road segments 301. Further a particular road 303 may include multiple directions associated with different flows of vehicular traffic. For example, road segment 301-1 may correspond to a first direction of travel associated with road 303, and road segment 301-2 may correspond to a second (e.g., opposing) direction of travel associated with road 303. Road segments 301 may be segments of road 303, and road 303 may further be segmented according to different directions of travel. For example, road 303-1 may be associated with a first set of segments (e.g., including segments 301-1 and 301-2), and road 303-2 may be associated with a second set of segments (e.g., including segment 301-3 and/or other segments).

Returning to FIG. 2, SOS 101 may generate one or more road segment models 201 for each respective road segment 301, and/or a particular road segment model 201 may be associated with multiple road segments 301. Road segment model 201 may, for example, include and/or may be based on KPIs and/or attributes associated with one or more particular road segments 301, such as location and/or boundary information 205, locale feature information 207, travel time information 209, vehicular speed information 211, and vehicular emissions information 213. In some embodiments, road segment model 201 may be based on additional KPIs and/or attributes, fewer KPIs and/or attributes, and/or different KPIs and/or attributes. As noted above, the KPIs and/or attributes associated with a given road segment 301 may be based on sensor data received from devices or systems that have measured such sensor data while located on (e.g., traveling on) road segment 301, and/or which otherwise are capable of collecting or measuring such sensor data (e.g., cameras pointed at road segment 301). In some embodiments, the KPIs and/or attributes of road segment 301 may be based on statistical data received from one or more information repositories or other sources that aggregate, collect, etc. such data. In some embodiments, the KPIs and/or attributes of road segment 301 may be determined or generated through simulations, modeling, or the like.

Location and/or boundary information 205 may include information defining the location and/or boundaries of a given road segment 301. For example, location and/or boundary information 205 may include latitude and longitude coordinates or other types of location information defining an entry point to a given road segment 301, an exit point from a given road segment 301, and/or other types of location information associated with road segment 301. Locale feature information 207 may include information indicating attributes and/or features of road segment 301 and/or a geographical area in which road segment 301 is located. For example, locale feature information 207 may include information relating to a quantity of lanes associated with road segment 301, a width of road segment 301, a bumpiness of road segment 301, an indication of hills or flatness of road segment 301, topographical features (e.g., mountains, valleys, forests, streams, etc.), weather-related information, and/or other factors that may affect or reflect navigation or traversal of road segment 301, and/or which may affect or be correlated with other attributes or KPIs associated with road segment 301.

Travel time information 209 may include information indicating an amount of time taken by vehicles to traverse road segment 301, with which road segment model 201 is associated. For example, travel time information 209 may reflect an average amount of time, a median amount of time, a maximum amount of time, a minimum amount of time, and/or some other value that reflects how long vehicles took to traverse road segment 301. A vehicle may, in some embodiments, be considered as “traversing” road segment 301 when the vehicle enters road segment 301 (e.g., at a starting point associated with road segment 301, which may be indicated by location and/or boundary information 205) and then exits road segment 301 (e.g., at an ending point associated with road segment 301, which may be indicated by location and/or boundary information 205). The travel time for a given vehicle via road segment 301 may thus be a function of a time at which the vehicle entered road segment 301 and a time at which the vehicle exited road segment 301.

Vehicular speed information 211 may indicate a speed of one or more vehicles while traversing road segment 301. In some embodiments, vehicular speed information 211 may include an average speed, a median speed, a maximum speed, a minimum speed, and/or some other value that reflects the speed of vehicles that traverse road segment 301. In some embodiments, vehicular speed information 211 may include granular or raw speed information, such as periodic and/or intermittently determined speed values for vehicles that traverse road segment 301. For example, such information may indicate that a particular vehicle traveled at a first speed during a first time interval (e.g., a 1-second interval, a 30-second interval, a 1-minute interval, etc.) along road segment 301, while the particular vehicle traveled at a different second speed during a second time interval along road segment 301.

Vehicular emissions information 213 may indicate an amount of vehicular emissions of vehicles that traverse road segment 301. For example, vehicular emissions information 213 may include an average amount of vehicular emissions, a median amount of vehicular emissions, a maximum amount of vehicular emissions, a minimum amount of vehicular emissions, and/or some other value that reflects the amount of vehicular emissions of vehicles that traverse road segment 301. As noted above, vehicular emissions may include carbon monoxide emissions, sulfur oxide emissions, nitrogen oxide emissions, and/or other types of emissions. In some embodiments, vehicular emissions may be measured or determined directly (e.g., by systems associated with vehicles causing such emissions) and/or may be determined or estimated using modeling techniques. For example, in some embodiments, vehicular emissions information 213 may be determined, estimated, modeled, etc. based on one or more other KPIs or attributes of a given road segment 301 (e.g., as indicated in road segment model 201 for the given road segment 301). In some embodiments, vehicular emissions information 213 may be determined (e.g., by SOS 101 and/or some other device or system) based on location and/or boundary information 205, locale feature information 207, travel time information 209, and/or vehicular speed information 211.

Generally, for example, a vehicle traveling at relatively slow speed (e.g., below a first threshold) or at a relatively high speed (e.g., above a second threshold) may be associated with relatively high vehicular emissions, while a vehicle traveling at a relatively moderate pace (e.g., between the first and second thresholds) may be associated with relatively low vehicular emissions. As another example, vehicles traveling uphill may be associated with relatively higher vehicular emissions than vehicles traveling downhill or on flat ground. Further different types (e.g., cars, trucks, motorcycles, etc.) of vehicles or vehicles with particular attributes (e.g., 4-cylinder engines, diesel engines, sedans, coupes, etc.) may be associated with different measures of vehicular emissions.

Vehicle model 203 may include represent, and/or be based on KPIs and/or attributes associated with one or more particular vehicles traveling along one or more road segments 301. For example, such information may be received from telematics systems or other systems integrated in the vehicles, UEs located in or communicatively coupled to the vehicles, and/or some other source. Vehicle model 203 may include, for example, vehicle type information 215, fuel consumption information 217, and/or other information.

Vehicle type information 215 may include a type of a given vehicle, such as a vehicle class (e.g., car, truck, motorcycle, coupe, sedan, etc.), a manufacturer of the vehicle, attributes of the vehicle (e.g., engine type, fuel type, etc.), and/or other identifying attributes of the type of the vehicle. Fuel consumption information 217 may include information indicating an amount of fuel consumed by the vehicle, and may be indicated with timestamps, location information, or the like.

As further shown, SOS 101 may generate or identify an affinity and/or correlation between different models 107, such as affinity and/or correlation 219. For example, a first road segment model 201 for a particular road segment 301 may be associated with a first vehicle model 203 (or a first set of vehicle models 203), while a second road segment model 201 for the same particular road segment 301 may be associated with second vehicle model 203 (or a second set of vehicle models 203). For example, different vehicles or types of vehicles may exhibit different KPIs, such as speed, emissions, etc. along the same road segment 301. As such, different models 201 may be generated or identified for the same road segment 301 but for different vehicles. Additionally, or alternatively, different KPIs and/or attributes of road segment model 201 may be correlated to different vehicle models 203. For example, road segment model 201 may include one set of vehicular emissions information 213 for a first vehicle model 203, and may include a second set of vehicular emissions information 213 for a second vehicle model 203. In this manner, models 107 may be dynamic and may reflect varying effects that different factors may have on the KPIs and/or attributes reflected in models 107.

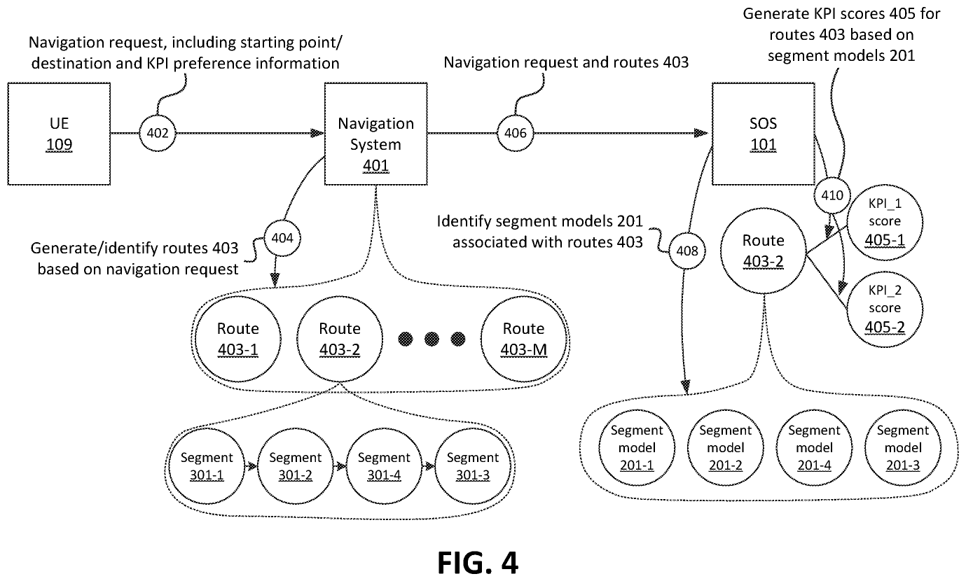

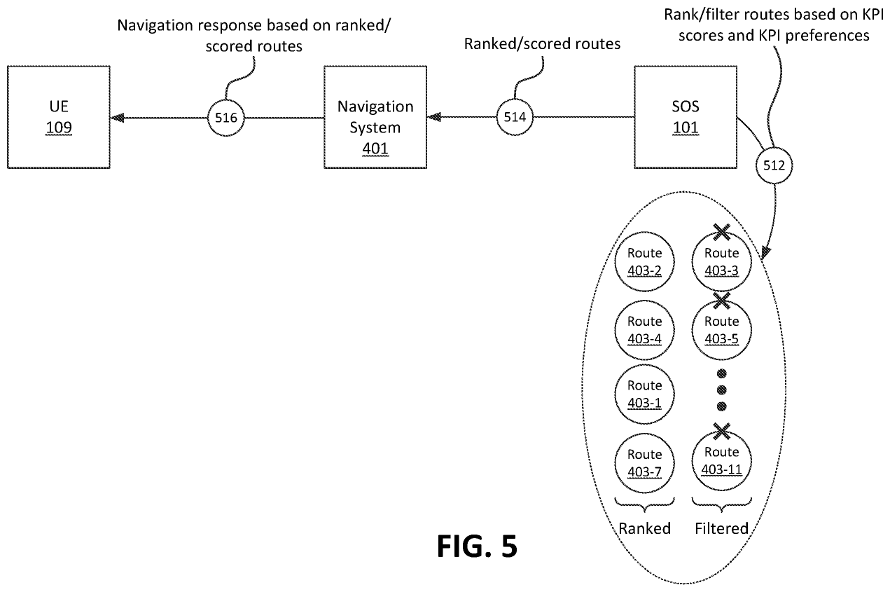

FIGS. 4 and 5 illustrate an example selection of one or more solutions that may be selected based on a ranking and/or filtering process (e.g., based on models 107) of some embodiments. FIGS. 4 and 5 are presented in the context of a navigation request, where the solution includes the identification of a set of road segments to navigate from a starting point specified in the request to a destination specified in the request. In practice, similar concepts may apply to the determination of other kinds of solutions based on models 107 associated with different nodes, states, etc. Further, in some embodiments, similar concepts may apply independent of a request, such as during a “precompute” operation or other type of operation.

As shown in FIG. 4, Navigation System 401 may receive (at 402) a navigation request from UE 109. The navigation request may include a start point and a destination, as well as KPI preference information. For example, as discussed above, the KPI preference indication may include an indication of one or more KPIs that are to be optimized, prioritized, etc. with respect to other KPIs in generating a solution (e.g., a route) in response to the navigation request. Navigation System 401 may generate and/or identify (at 404) a set of candidate routes 403 that satisfy the navigation request. For example, routes 403 may be “valid” solutions inasmuch as routes 403 include routes that may be used to arrive at the specified destination from the specified starting point. Route 403-2, for instance, may include an ordered sequence of road segments 301 (i.e., road segment 301-1, then road segment 301-2, then road segment 301-4, and then road segment 301-3). Routes 403, determined by Navigation System 401, may not necessarily have been determined with respect to the KPI preference information. For example, some or all of routes 403, and/or portions thereof, may have been determined during a “precompute” operation and/or some other operation prior to receiving (at 402) the navigation request.

In some embodiments, Navigation System 401 may be a separate system with respect to SOS 101, which may communicate with SOS 101 via an API or other suitable communication pathway. Navigation System 401 may provide (at 406) the navigation request (e.g., including the KPI preference information) and one or more of the identified (at 404) routes 403 to SOS 101. As discussed below, SOS 101 may further filter, rank, and/or perform one or more other operations to identify one or more routes 403 to provide in response to the KPI preference information included in the navigation request.

For example, SOS 101 may identify (at 408) segment models 201 that are associated with each route 403. In this example, with respect to route 403-2 (e.g., one particular route 403 of the set of candidate routes 403 identified by Navigation System 401), SOS 101 may identify segment models 201-1, 201-2, 201-3, and 201-4, which may be associated with segments 301-1, 301-2, 301-3, and 301-4 that are included in route 403-2. SOS 101 may further generate or identify (at 410) KPI scores 405 for each route 403 of the set of candidate routes 403. KPI scores 405 for a given route 403 may be based on, for example, KPI information specified in models 201 associated with respective road segments 301 included in route 403. For example, KPI score 405-1 may be based on vehicular emissions information 213 associated with road segment models 201-1 through 201-4, associated with route 403-2. KPI score 405-1 may be generated based on an average, median, and/or other computed value that is based on vehicular emissions information 213 indicated in road segment models 201-1 through 201-4. In some embodiments, KPI scores 405 may be normalized to the same scale, such as 1 through 10, −100 through 100, 1 through 100, and/or some other scale. For example, while travel time information 209, vehicular speed information 211, and vehicular emissions information 213 may include values using different units or ranges, KPI scores 405 that are generated based on travel time information 209, vehicular speed information 211, and/or vehicular emissions information 213 associated with respective road segment models 201 may be on the same normalized scale.

In some embodiments, the navigation request may include additional information, and/or SOS 101 may identify additional information from a user information repository (e.g., a Unified Data Management function (“UDM”), a Home Subscriber Server (“HSS”), or some other suitable device or system), based on which SOS 101 may select particular road segment models 201 and/or portions thereof. For example, the navigation request may include attribute information regarding a particular vehicle with which the navigation request is associated, such as a vehicle that will be used to traverse a route that is provided as a solution to the navigation request. Based on such information, SOS 101 may identify KPIs or KPI values, of road segment models 201, that are correlated with or are associated with (e.g., based on affinity and/or correlation information 219) a particular vehicle model 203 that corresponds to the attributes of the vehicle associated with the navigation request. In this manner, SOS 101 may further tailor the KPI scoring to the particular attributes of the solution request.

In some embodiments, SOS 101 may generate particular KPI scores 405 based on different weights, coefficients, or the like. For example, the weights, coefficients, etc. may be based on KPI preference information provided in the navigation request. If, for example, the navigation request indicates a 60% preference for a first KPI (e.g., travel time information 209) and a 40% preference for a second KPI (e.g., vehicular emissions information 213), SOS 101 may utilize a first weight or coefficient, based on the 60% preference, for a first KPI score 405-1 associated with the first KPI, and may utilize a second weight or coefficient, based on the 40% preference, for a second KPI score 405-2 associated with the second KPI.

As shown in FIG. 5, SOS 101 may rank and/or filter routes 403 based on the KPI scores 405 and/or the KPI preferences. For example, SOS 101 may generate aggregate scores for routes 403 based on the KPI scores 405 (generated at 410) and/or weights, coefficients, etc. that are based on KPI preferences associated with the solution request. The aggregate score for a given route 403 may be an average, median, and/or other suitable value derived from the KPI scores 405 associated with the given route 403. In some embodiments, SOS 101 may filter routes 403 having aggregate scores that are below a threshold aggregate score, and/or that have aggregate scores that are lower than a particular quantity of highest-ranking routes 403.

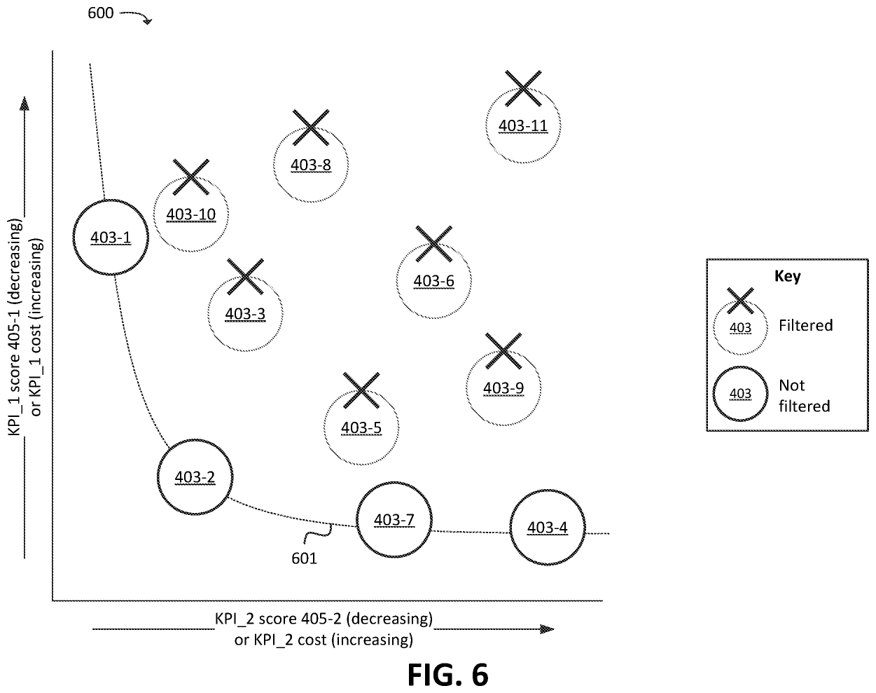

Additionally, or alternatively, SOS 101 may perform a multi-dimensional analysis, based on multiple KPIs associated with models 201 included in routes 403, and further based on KPI preferences, to rank and/or filter (at 510) routes 403. For example, as shown in FIG. 6, graph 600 may represent a set of routes 403-1 through 403-11 in terms of two different KPI scores 405-1 and 405-2 for each route 403. Routes 403-1 through 403-11 may be, for example, a set of candidate routes 403 identified (e.g., at 404) in response to a navigation request. As another example, graph 600 may include data points that each correspond to another type of solution (e.g., in contexts other than navigation routes 403), where each solution is associated with different sets of KPI scores 405.

In this example, route 403-1 may be associated with a relatively low value for KPI score 405-1 and a relatively high value for KPI score 405-2. That is, in this figure, the Y-axis represents decreasing values for KPI score 405-1 (or increasing “costs” associated with the KPI on which KPI score 405-1 is based), and the X-axis represents decreasing values for KPI score 405-2 (or increasing “costs” associated with the KPI on which KPI score 405-2 is based). As another example, route 403-4 may be associated with a relatively high value for KPI score 405-1 (e.g., and/or a low “cost”) and a relatively low value for KPI score 405-2 (e.g., and/or a relatively high “cost”). As a further example, route 403-11 may be associated with relatively low values for both KPI scores 405-1 and 405-2.

SOS 101 may perform a multi-dimensional analysis to filter out one or more routes 403. The filtering may be performed based on a multi-dimensional comparison of values of KPI scores 405-1 and 405-2 associated with respective routes 403. For example, SOS 101 may generate threshold curve 601 based on a distribution of routes 403 in graph 600 (e.g., where such distribution is based on KPI scores 405 associated with routes 403). In some embodiments, threshold curve 601 may be or may be based on a Pareto set (sometimes also referred to as a Pareto front or a Pareto frontier) of routes 403 in graph 600. Routes 403 that bear a particular relationship to threshold curve 601 (e.g., routes 403 that fall on threshold curve 601, routes 403 within a threshold distance of threshold curve 601, routes 403 that are above or below threshold curve 601, etc.) may be the Pareto set of routes 403 out of the candidate set of routes 403. In this example, the Pareto set may include routes 403-1, 403-2, 403-4, and 403-7. The routes 403 that are not in the Pareto set may be filtered by SOS 101, where filtering refers to identifying such routes 403 as ineligible solutions, given a particular set of KPI preferences, weights, etc. The filtered routes 403 may be filtered based on being Pareto-dominated by one or more of the routes 403 in the Pareto set.

Thus, using the example values shown in FIG. 6, the candidate set of routes 403 provided (at 406) to SOS 101 may include routes 403-1 through 403-11, of which routes 403-3, 403-5, 403-6, 403-8, 403-9, 403-10, and 403-11 may be filtered. Thus, the eligible set of routes 403, determined (e.g., at 512) by SOS 101 may include routes 403-1, 403-2, 403-4, and 403-7. In some embodiments, SOS 101 may select a particular route 403 from the set of eligible routes 403, and/or may select multiple routes 403 from the set of eligible routes 403. In some embodiments, SOS 101 may rank routes 403 of the eligible set of routes 403 based on an aggregate score associated with routes 403 of the eligible set of routes 403. As noted above, the aggregate score for a particular route 403 may be based on KPI scores 405 associated with the particular route 403 (e.g., KPI scores 405-1 and 405-2, in the example of FIG. 6). In some embodiments, the aggregate score and/or KPI scores 405 may be based on weights associated with KPI preferences included in a solution request.

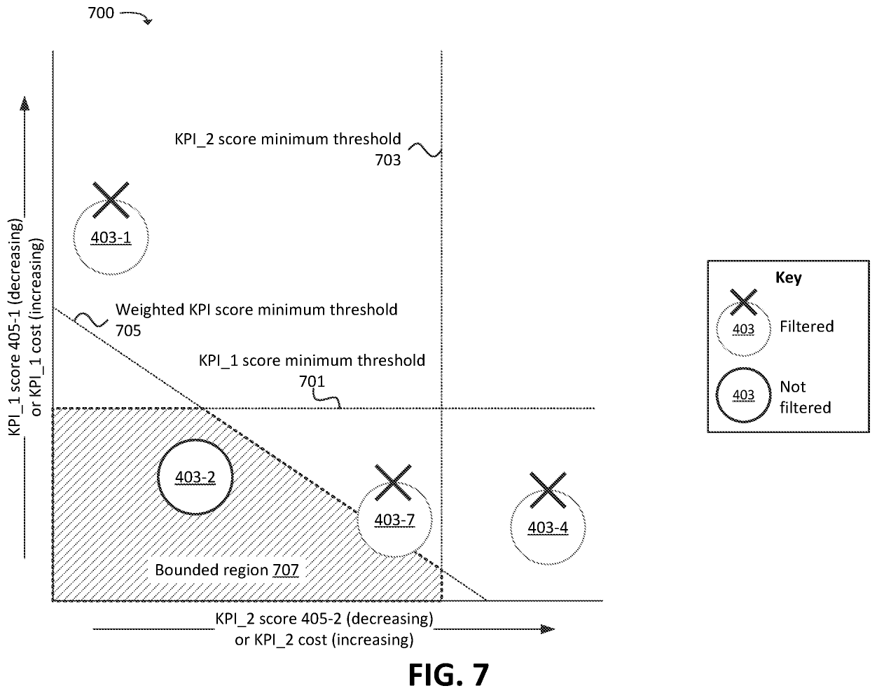

In some embodiments, the filtering (at 512) may include filtering based on constraints indicated in the KPI request, such as minimum scores 405 for one or more KPIs and/or other factors. For example, as shown in FIG. 7, referring to the same eligible solution set of routes 403 shown in FIG. 6, the solution set may further be filtered based on one or more minimum KPI score 405 thresholds specified in a given solution request. For example, the solution request may include (and/or SOS 101 may otherwise determine) a minimum score threshold 701 for KPI score 405-1, and/or minimum score threshold 703 for KPI score 405-2. In the example of FIG. 7, route 403-1 may be filtered by virtue of being associated with a lower KPI score 405-1 (and/or a higher cost for the KPI associated with KPI score 405-1) than threshold 701, and route 403-4 may be filtered by virtue of being associated with a lower KPI score 405-2 (and/or a higher cost for the KPI associated with KPI score 405-2) than threshold 703.

As further shown, a composite threshold 705 may be based on threshold 701, threshold 703, and/or one or more weights associated with KPI scores 405-1 and 405-2 (e.g., as specified in or otherwise associated with KPI preferences associated with a given solution request). Additionally, or alternatively, threshold 705 may be a minimum threshold for an aggregate score associated with eligible routes 403. Threshold 705 may, for example, be based on weights associated with a set of KPI preferences. For example, a set of KPI preferences that weights KPI score 405-1 more heavily may be less steep on the Y-axis of graph 700, while a set of KPI preferences that weights KPI score 405-2 more heavily may be steeper on the Y-axis of graph 700. As such, different solutions (e.g., routes 403) may be eligible based on differing KPI preferences associated with differing solution requests. That is, thresholds 701, 703, and 705 shown in FIG. 7 are example thresholds that may be used to select or filter solutions (e.g., routes 403) based on KPI preferences associated with a solution request (e.g., a navigation request). In practice, fewer, additional, different, or differently arranged thresholds may be used. Further, while thresholds 701, 703, and 705 are shown in FIG. 7 as lines, thresholds of some embodiments may be curves or other types of bounds.

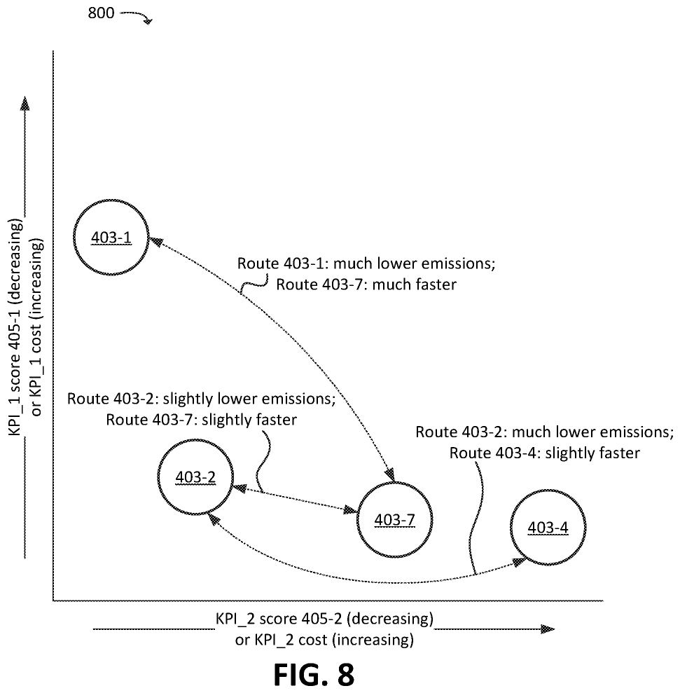

In some embodiments, SOS 101 may identify relative characteristics of different candidate solutions (e.g., routes 403), in order to present different alternatives that a user may use to subjectively select a particular solution. For example, as shown in graph 800 of FIG. 8, routes 403-1, 403-2, 403-4, and 403-7 may be a set of routes identified based on a filtering process (e.g., as shown in FIG. 6). For example, such routes 403 may represent a Pareto set of routes 403, where other routes 403 have been filtered.

SOS 101 may identify relative differences in one or more KPIs associated with respective routes 403. For example, as shown, SOS 101 may identify, with respect to routes 403-1 and 403-7, that route 403-1 is associated with much lower vehicular emissions than route 403-7, and that route 403-7 is associated a much lower travel time than route 403-1 (e.g., much faster). As another example, with respect to routes 403-2 and 403-4, that route 403-2 is associated with much lower vehicular emissions than route 403-4, and that route 403-4 is associated with a slightly lower travel time (e.g., slightly faster) than route 403-2. While terms such as “much” or “slightly” are used here for the sake of explanation, in practice, SOS 101 may utilize other classifications and/or may identify a difference between particular KPI scores 405. For example, a “much” comparative classification may represent a relatively large difference in KPI scores 405, for the same KPI associated with different routes 403, such as a difference that exceeds a first threshold difference. On the other hand, a “slightly” comparative classification may represent a relatively small difference in KPI scores 405, for the same KPI associated with different routes 403, such as a difference that does not exceed the first threshold difference (and/or is less than a second threshold difference). While only some comparative relationships between routes 403 are illustrated in FIG. 8, in practice, SOS 101 may identify comparative relationships between some or all solutions (e.g., routes 403) of a candidate solution set.

In some embodiments, FIG. 8 conceptually illustrates an “exploration” of different solutions based on different KPI preferences, objectives, weights, etc. For example, assume that SOS 101 initially identifies route 403-1 as a solution to a given navigation request based on a set of KPI preferences that prioritize vehicular emissions objectives over travel time objectives. SOS 101 may, after identifying route 403-1, modify weights associated with the vehicular emissions objectives and travel time objectives to identify one or more other routes 403, and the rationale or reasons behind the other routes 403 as compared to route 403-1 and/or each other. For example, after identifying route 403-1, SOS 101 may reduce a weight associated with the vehicular emissions KPI and/or increase a weight associated with the travel time KPI. Based on such adjustments, SOS 101 may identify route 403-7 (e.g., from a Pareto set of routes 403), and may further identify reasons that route 403-7 may be selected over route 403-1, or vice versa. For example, as noted above, route 403-7 may be much faster (e.g., much lower travel time) than route 403-1, and route 403-1 may be associated with much lower vehicular emissions.

Similarly, after identifying route 403-7 as a higher vehicular emission and lower travel time alternative to route 403-1, SOS 101 may identify that route 403-2 is associated with slightly lower vehicular emissions than route 403-7, while route 403-7 is slightly faster than route 403-2. SOS 101 may further identify relative differences between routes 403-2 and 403-4 in a similar manner. While only three comparative relationships are shown in FIG. 8, in practice, SOS 101 may identify numerous comparative relationships between multiple different solutions, including identifying multiple relationships associated with a single solution. For example, SOS 101 may identify comparative relationships between route 403-1 and route 403-2, as well as between route 403-1 and 403-4.

While FIGS. 6-8 are presented in the context of two KPIs, and therefore two-dimensional graphs 600, 700, and 800, in practice, similar concepts may be applied for three or more KPIs. In this manner, a multi-dimensional analysis may be performed to filter candidate solutions (e.g., to identify a Pareto set of solutions) based on multiple KPIs and KPI preferences, and to identify comparative relationships between various solutions.

Returning to FIG. 4, SOS 101 may provide (at 514) one or more solutions (e.g., one or more routes 403) to Navigation System 401, which may provide (at 516) a response to the solution request (e.g., navigation request) that includes some or all of the indicated solutions (e.g., routes 403). For example, the solutions (e.g., routes 403) provided (at 514 and/or 516) may include one or more solutions of a Pareto set of solutions that was generated based on KPI preferences associated with the solution request, as similarly discussed above with respect to FIGS. 6-8. In some embodiments, the response (e.g., provided at 514 and/or 516) may include a ranking of solutions, where such ranking is performed based on KPI scores 405 associated with particular solutions, overall scores that are based on KPI scores 405, and/or weights that are based on KPI preferences indicated in the solution request. For example, as discussed above, for a particular KPI that is more strongly indicated in the solution request, the weight for the corresponding KPI score 405 may be higher than for a KPI score 405 that is associated with some other KPI. In some embodiments, the set of solutions (provided at 514 and/or 516) may omit one or more candidate solutions, where such omission is based on such solutions not being in a Pareto set of solutions, and/or based on some other suitable elimination or filtering procedure. In some embodiments, the solutions may be provided (e.g., at 514 and/or 516) with comparative information, such as indications of which KPIs are scored higher or lower for particular solutions (e.g., as similarly described above with respect to FIG. 8).

UE 109 may present some or all of the provided solutions. For example, in the context of a navigation request, UE 109 may overlay one or more provided routes 403 on a map, and may present one or more selectable options for a user of UE 109 to select a particular route 403. In some embodiments, UE 109 may present comparative information, that indicates different KPIs for different routes 403, and/or that indicates a measure of comparison of such KPIs between different routes 403. Once a particular route 403 has been selected, UE 109 may present navigation directions in accordance with the selected route 403. As each UE 109 (and/or each solution request) may be associated with different KPI preferences, the provided solutions (e.g., routes 403 and/or other types of solutions) may be able to be custom tailored and more relevant to a user of UE 109. Further, such user may be provided with a level of information that allows the user to make an informed decision between different solutions.

While FIGS. 4 and 5 are presented in the context of Navigation System 401, in practice, similar concepts may apply to other types of devices or systems. For example, a route planning system may utilize similar concepts to identify which vehicles, of a fleet of vehicles, should go to which destination of a set of destinations. Such route planning may include the identification of particular routes for vehicles to take (e.g., based on KPIs such as travel time, vehicular emissions, fuel consumption, etc.), which vehicles should take which routes or should go to which destination (e.g., where a vehicle that consumes relatively more fuel may be selected to travel to a destination that is relatively close to the vehicle), etc.

Further, while Navigation System 401 and SOS 101 are shown as separate systems in FIGS. 4 and 5, in practice, the same device or system may perform some or all of the functions discussed above with respect to Navigation System 401 and SOS 101, and/or one or more other devices or systems may perform some of the functions discussed above with respect to Navigation System 401 and SOS 101.

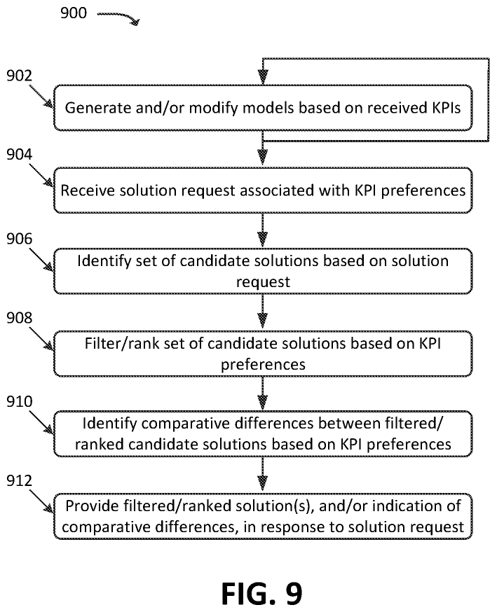

FIG. 9 illustrates an example process 900 for identifying and providing solutions that are tailored to KPI preferences associated with a solution request (e.g., a routing request or other type of request). In some embodiments, some or all of process 900 may be performed by SOS 101. In some embodiments, one or more other devices may perform some or all of process 900 in concert with, and/or in lieu of, SOS 101.

As shown, process 900 may include generating and/or modifying (at 902) a set of models based on received KPIs. For example, as discussed above, SOS 101 may receive KPIs from one or more suitable devices or systems, where such KPIs indicate measured and/or simulated values, attributes, characteristics, metrics, or the like. Such KPIs may include measures of performance, quality, robustness, or other values. For example, as discussed above with respect to FIG. 2, such KPIs may include and/or may be used to identify attributes of one or more models 107, which may include different types of models. In some embodiments, SOS 101 may identify a measure of affinity and/or correlation 219 between one or more models 107, which may include measures of affinity and/or correlation 219 between different types of models 107 (e.g., models 107 that are associated with different sets of KPIs). SOS 101 may use AI/ML techniques or other suitable techniques to generate models 107, and/or to refine such models 107 based on continuing to receive KPIs and/or feedback information associated with models 107 and/or KPIs. The feedback information may be used to strengthen and/or weaken the association of particular KPIs or KPI values with particular models 107.

Process 900 may further include receiving (at 904) a solution request that is associated with a set of KPI preferences. For example, as discussed above, the solution request may include a routing request or other suitable type of request that indicates a starting condition (e.g., a start point) and an exit condition (e.g., a destination). The solution request may be generated manually (e.g., by a user initiating a navigation request, a technician initiating a network routing diagnostic, or the like) and/or may be generated automatically. In some embodiments, an automatically generated solution request may be generated as part of a “precompute” or “learning” operation, in which a request from a user need not be received.

As noted above, the solution request may include and/or may otherwise be associated with a set of KPI preferences, which may indicate a weight, preference, priority, etc. of one or more particular KPIs. In some embodiments, the solution request may include and/or may otherwise be associated with a set of maximum or minimum KPI thresholds, where solutions that do not satisfy such thresholds (e.g., are above a maximum threshold or are below a minimum threshold) should be eliminated from consideration as possible solutions for the particular solution request.

Process 900 may additionally include identifying (at 906) a set of candidate solutions based on the solution request. For example, SOS 101 may identify a set of solutions that satisfy the starting condition and the exit condition associated with the solution request. For example, in the context of navigation, the set of candidate solutions may include multiple routes 403 that begin at a starting location and end at a specified destination location. In the context of network routing, the set of candidate solutions may include multiple network routes or hops that begin at a starting address (e.g., a network address, such as an Internet Protocol (“IP”) address, a Uniform Resource Locator (“URL”), etc.) and end at a specified destination network address.

Each set of candidate solutions may be associated with one or more models 107, where such models 107 are associated with intermediate steps, states, etc. associated with a given candidate solution. Such models 107 may each be associated with one or more scores, costs, etc. that are based on KPI values associated with such models 107. In some embodiments, SOS 101 may generate a weighted aggregate score for each candidate solution, where a weight for a particular KPI value is determined based on KPI preferences associated with the solution request.

Process 900 may also include filtering and/or ranking (at 908) the set of candidate solutions based on the KPI preferences. For example, as discussed above, SOS 101 may identify and filter (e.g., remove) solutions of the set of candidate solutions that are unlikely to be ultimately selected over other solutions. Filtering candidate solutions that are unlikely to be ultimately selected over other solutions may reduce processing time and/or resources that may have otherwise been expended to analyze such solutions, such as determining whether such solutions meet KPI preferences or exceed thresholds (e.g., as discussed above with respect to FIG. 7) and/or identifying relative characteristics or KPIs between different solutions (e.g., as discussed above with respect to FIG. 8).

In some embodiments, such identification and filtering may include identifying a Pareto set of solutions, where solutions that are not in the Pareto set are filtered (e.g., removed from consideration). In some embodiments, SOS 101 may identify different filtered sets (e.g., Pareto sets) of solutions for different KPI preferences. In some embodiments, SOS 101 may filter candidate solutions that do not satisfy KPI thresholds associated with the solution request. For example, SOS 101 may filter candidate solutions with KPI scores or values that exceed maximum threshold values, and/or may filter candidate solutions with KPI scores or values that do not exceed minimum threshold values. As another example, SOS 101 filter candidate solutions with KPI scores or values that do not satisfy one or more composite thresholds that are determined based on KPI preferences associated with the solution request. In some embodiments, SOS 101 may rank some or all of the filtered set of solutions (e.g., the Pareto set) based on an aggregate score associated with such solutions. As discussed above, the aggregate score for a given solution may be based on KPI scores 405 associated with models 107 included in the given solution. Further, as discussed above, such aggregate score may further be based on KPI preferences associated with the solution request.

Process 900 may further include identifying (at 910) comparative differences between the solutions of the filtered and/or ranked set of solutions. For example, as discussed above, SOS 101 may identify differences in particular KPI scores 405 associated with the solutions, which may include identifying qualitative differences (e.g., “much greater,” “slightly faster,” “much lower,” etc.) between particular KPIs of the different solutions. In some embodiments, SOS 101 may identify a difference in KPI scores 405 for one or more KPIs associated with the different solutions.

Process 900 may additionally include providing (at 912) the filtered and/or ranked solutions, and/or the indication of comparative differences, in response to the solution request. For example, SOS 101 may provide a response that indicates the filtered set of solutions, a highest scoring or ranked solution, a ranking of the filtered set of solutions, or the like. SOS 101 may also indicate differences between the solutions (e.g., based on the identification (at 910) of the comparative differences), in order to allow the requestor to ultimately make an informed decision in selecting a particular solution.

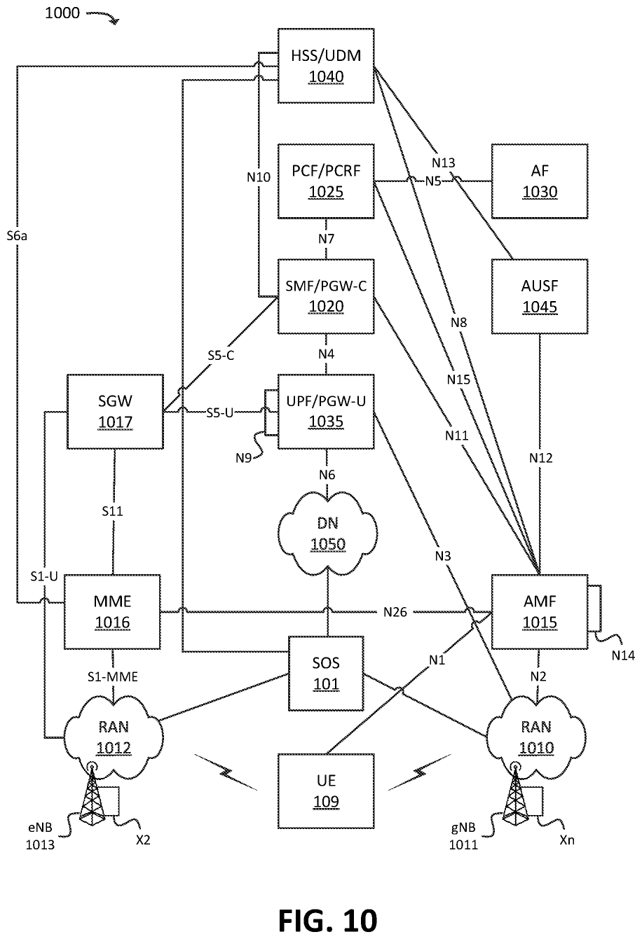

FIG. 10 illustrates an example environment 1000, in which one or more embodiments may be implemented. In some embodiments, environment 1000 may correspond to a Fifth Generation (“5G”) network, and/or may include elements of a 5G network. In some embodiments, environment 1000 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 1000 may include UE 109, RAN 1010 (which may include one or more Next Generation Node Bs (“gNBs”) 1011), RAN 1012 (which may include one or more one or more evolved Node Bs (“eNBs”) 1013), and various network functions such as Access and Mobility Management Function (“AMF”) 1015, Mobility Management Entity (“MME”) 1016, Serving Gateway (“SGW”) 1017, Session Management Function (“SMF”)/Packet Data Network (“PDN”) Gateway (“PGW”)-Control plane function (“PGW-C”) 1020, Policy Control Function (“PCF”)/Policy Charging and Rules Function (“PCRF”) 1025, Application Function (“AF”) 1030, User Plane Function (“UPF”)/PGW-User plane function (“PGW-U”) 1035, Home Subscriber Server (“HSS”)/Unified Data Management (“UDM”) 1040, and Authentication Server Function (“AUSF”) 1045. Environment 1000 may also include one or more networks, such as Data Network (“DN”) 1050. Environment 1000 may include one or more additional devices or systems communicatively coupled to one or more networks (e.g., DN 1050), such as SOS 101, which may be a device or system that performs some or all of the operations discussed above.

The example shown in FIG. 10 illustrates one instance of each network component or function (e.g., one instance of SMF/PGW-C 1020, PCF/PCRF 1025, UPF/PGW-U 1035, HSS/UDM 1040, and/or AUSF 1045). In practice, environment 1000 may include multiple instances of such components or functions. For example, in some embodiments, environment 1000 may include multiple “slices” of a core network, where each slice includes a discrete set of network functions (e.g., one slice may include a first instance of SMF/PGW-C 1020, PCF/PCRF 1025, UPF/PGW-U 1035, HSS/UDM 1040, and/or AUSF 1045, while another slice may include a second instance of SMF/PGW-C 1020, PCF/PCRF 1025, UPF/PGW-U 1035, HSS/UDM 1040, and/or AUSF 1045). The different slices may provide differentiated levels of service, such as service in accordance with different Quality of Service (“QoS”) parameters.

The quantity of devices and/or networks, illustrated in FIG. 10, is provided for explanatory purposes only. In practice, environment 1000 may include additional devices and/or networks, fewer devices and/or networks, different devices and/or networks, or differently arranged devices and/or networks than illustrated in FIG. 10. For example, while not shown, environment 1000 may include devices that facilitate or enable communication between various components shown in environment 1000, such as routers, modems, gateways, switches, hubs, etc. Alternatively, or additionally, one or more of the devices of environment 1000 may perform one or more network functions described as being performed by another one or more of the devices of environment 1000. Devices of environment 1000 may interconnect with each other and/or other devices via wired connections, wireless connections, or a combination of wired and wireless connections. In some implementations, one or more devices of environment 1000 may be physically integrated in, and/or may be physically attached to, one or more other devices of environment 1000.

UE 109 may include a computation and communication device, such as a wireless mobile communication device that is capable of communicating with RAN 1010, RAN 1012, and/or DN 1050. UE 109 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Machine-to-Machine (“M2M”) device, or another type of mobile computation and communication device. UE 109 may send traffic to and/or receive traffic (e.g., user plane traffic) from DN 1050 via RAN 1010, RAN 1012, and/or UPF/PGW-U 1035.

RAN 1010 may be, or may include, a 5G RAN that includes one or more base stations (e.g., one or more gNBs 1011), via which UE 109 may communicate with one or more other elements of environment 1000. UE 109 may communicate with RAN 1010 via an air interface (e.g., as provided by gNB 1011). For instance, RAN 1010 may receive traffic (e.g., voice call traffic, data traffic, messaging traffic, signaling traffic, etc.) from UE 109 via the air interface, and may communicate the traffic to UPF/PGW-U 1035, and/or one or more other devices or networks. Similarly, RAN 1010 may receive traffic intended for UE 109 (e.g., from UPF/PGW-U 1035, AMF 1015, and/or one or more other devices or networks) and may communicate the traffic to UE 109 via the air interface.

RAN 1012 may be, or may include, a LTE RAN that includes one or more base stations (e.g., one or more eNBs 1013), via which UE 109 may communicate with one or more other elements of environment 1000. UE 109 may communicate with RAN 1012 via an air interface (e.g., as provided by eNB 1013). For instance, RAN 1010 may receive traffic (e.g., voice call traffic, data traffic, messaging traffic, signaling traffic, etc.) from UE 109 via the air interface, and may communicate the traffic to UPF/PGW-U 1035, and/or one or more other devices or networks. Similarly, RAN 1010 may receive traffic intended for UE 109 (e.g., from UPF/PGW-U 1035, SGW 1017, and/or one or more other devices or networks) and may communicate the traffic to UE 109 via the air interface.

AMF 1015 may include one or more devices, systems, Virtualized Network Functions (“VNFs”), etc., that perform operations to register UE 109 with the 5G network, to establish bearer channels associated with a session with UE 109, to hand off UE 109 from the 5G network to another network, to hand off UE 109 from the other network to the 5G network, manage mobility of UE 109 between RANs 1010 and/or gNBs 1011, and/or to perform other operations. In some embodiments, the 5G network may include multiple AMFs 1015, which communicate with each other via the N14 interface (denoted in FIG. 10 by the line marked “N14” originating and terminating at AMF 1015).

MME 1016 may include one or more devices, systems, VNFs, etc., that perform operations to register UE 109 with the EPC, to establish bearer channels associated with a session with UE 109, to hand off UE 109 from the EPC to another network, to hand off UE 109 from another network to the EPC, manage mobility of UE 109 between RANs 1012 and/or eNBs 1013, and/or to perform other operations.

SGW 1017 may include one or more devices, systems, VNFs, etc., that aggregate traffic received from one or more eNBs 1013 and send the aggregated traffic to an external network or device via UPF/PGW-U 1035. Additionally, SGW 1017 may aggregate traffic received from one or more UPF/PGW-Us 1035 and may send the aggregated traffic to one or more eNBs 1013. SGW 1017 may operate as an anchor for the user plane during inter-eNB handovers and as an anchor for mobility between different telecommunication networks or RANs (e.g., RANs 1010 and 1012).

SMF/PGW-C 1020 may include one or more devices, systems, VNFs, etc., that gather, process, store, and/or provide information in a manner described herein. SMF/PGW-C 1020 may, for example, facilitate the establishment of communication sessions on behalf of UE 109. In some embodiments, the establishment of communications sessions may be performed in accordance with one or more policies provided by PCF/PCRF 1025.

PCF/PCRF 1025 may include one or more devices, systems, VNFs, etc., that aggregate information to and from the 5G network and/or other sources. PCF/PCRF 1025 may receive information regarding policies and/or subscriptions from one or more sources, such as subscriber databases and/or from one or more users (such as, for example, an administrator associated with PCF/PCRF 1025).

AF 1030 may include one or more devices, systems, VNFs, etc., that receive, store, and/or provide information that may be used in determining parameters (e.g., quality of service parameters, charging parameters, or the like) for certain applications.

UPF/PGW-U 1035 may include one or more devices, systems, VNFs, etc., that receive, store, and/or provide data (e.g., user plane data). For example, UPF/PGW-U 1035 may receive user plane data (e.g., voice call traffic, data traffic, etc.), destined for UE 109, from DN 1050, and may forward the user plane data toward UE 109 (e.g., via RAN 1010, SMF/PGW-C 1020, and/or one or more other devices). In some embodiments, multiple UPFs 1035 may be deployed (e.g., in different geographical locations), and the delivery of content to UE 109 may be coordinated via the N9 interface (e.g., as denoted in FIG. 10 by the line marked “N9” originating and terminating at UPF/PGW-U 1035). Similarly, UPF/PGW-U 1035 may receive traffic from UE 109 (e.g., via RAN 1010, SMF/PGW-C 1020, and/or one or more other devices), and may forward the traffic toward DN 1050. In some embodiments, UPF/PGW-U 1035 may communicate (e.g., via the N4 interface) with SMF/PGW-C 1020, regarding user plane data processed by UPF/PGW-U 1035.

HSS/UDM 1040 and AUSF 1045 may include one or more devices, systems, VNFs, etc., that manage, update, and/or store, in one or more memory devices associated with AUSF 1045 and/or HSS/UDM 1040, profile information associated with a subscriber. AUSF 1045 and/or HSS/UDM 1040 may perform authentication, authorization, and/or accounting operations associated with the subscriber and/or a communication session with UE 109.

DN 1050 may include one or more wired and/or wireless networks. For example, DN 1050 may include an Internet Protocol (“IP”)-based PDN, a wide area network (“WAN”) such as the Internet, a private enterprise network, and/or one or more other networks. UE 109 may communicate, through DN 1050, with data servers, other UEs 109, and/or to other servers or applications that are coupled to DN 1050. DN 1050 may be connected to one or more other networks, such as a public switched telephone network (“PSTN”), a public land mobile network (“PLMN”), and/or another network. DN 1050 may be connected to one or more devices, such as content providers, applications, web servers, and/or other devices, with which UE 109 may communicate.

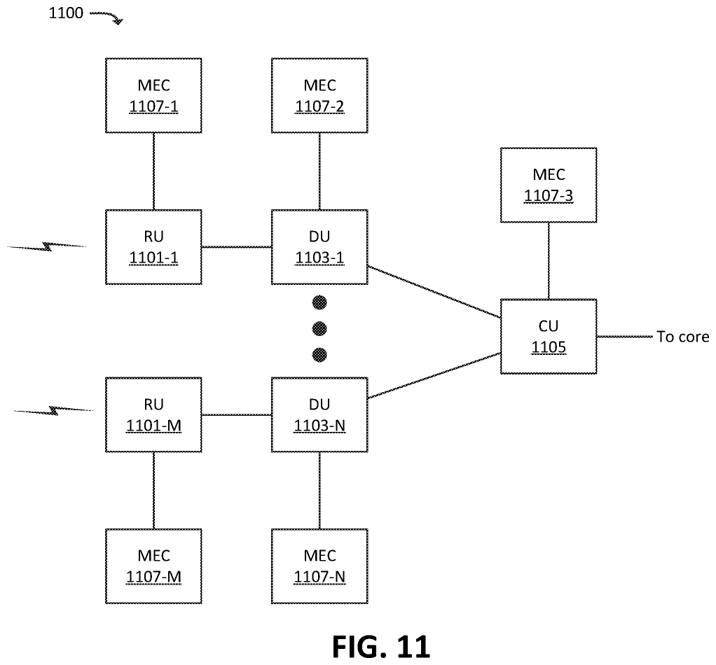

FIG. 11 illustrates an example Distributed Unit (“DU”) network 1100, which may be included in and/or implemented by one or more RANs (e.g., RAN 1010, RAN 1012, or some other RAN). In some embodiments, a particular RAN may include one DU network 1100. In some embodiments, a particular RAN may include multiple DU networks 1100. In some embodiments, DU network 1100 may correspond to a particular gNB 1011 of a 5G RAN (e.g., RAN 1010). In some embodiments, DU network 1100 may correspond to multiple gNBs 1011. In some embodiments, DU network 1100 may correspond to one or more other types of base stations of one or more other types of RANs. As shown, DU network 1100 may include Central Unit (“CU”) 1105, one or more Distributed Units (“DUs”) 1103-1 through 1103-N (referred to individually as “DU 1103,” or collectively as “DUs 1103”), and one or more Radio Units (“RUs”) 1101-1 through 1101-M (referred to individually as “RU 1101,” or collectively as “RUs 1101”).

CU 1105 may communicate with a core of a wireless network (e.g., may communicate with one or more of the devices or systems described above with respect to FIG. 10, such as AMF 1015 and/or UPF/PGW-U 1035). In the uplink direction (e.g., for traffic from UEs 109 to a core network), CU 1105 may aggregate traffic from DUs 1103, and forward the aggregated traffic to the core network. In some embodiments, CU 1105 may receive traffic according to a given protocol (e.g., Radio Link Control (“RLC”)) from DUs 1103, and may perform higher-layer processing (e.g., may aggregate/process RLC packets and generate Packet Data Convergence Protocol (“PDCP”) packets based on the RLC packets) on the traffic received from DUs 1103.

In accordance with some embodiments, CU 1105 may receive downlink traffic (e.g., traffic from the core network) for a particular UE 109, and may determine which DU(s) 1103 should receive the downlink traffic. DU 1103 may include one or more devices that transmit traffic between a core network (e.g., via CU 1105) and UE 109 (e.g., via a respective RU 1101). DU 1103 may, for example, receive traffic from RU 1101 at a first layer (e.g., physical (“PHY”) layer traffic, or lower PHY layer traffic), and may process/aggregate the traffic to a second layer (e.g., upper PHY and/or RLC). DU 1103 may receive traffic from CU 1105 at the second layer, may process the traffic to the first layer, and provide the processed traffic to a respective RU 1101 for transmission to UE 109.

RU 1101 may include hardware circuitry (e.g., one or more RF transceivers, antennas, radios, and/or other suitable hardware) to communicate wirelessly (e.g., via an RF interface) with one or more UEs 109, one or more other DUs 1103 (e.g., via RUs 1101 associated with DUs 1103), and/or any other suitable type of device. In the uplink direction, RU 1101 may receive traffic from UE 109 and/or another DU 1103 via the RF interface and may provide the traffic to DU 1103. In the downlink direction, RU 1101 may receive traffic from DU 1103, and may provide the traffic to UE 109 and/or another DU 1103.

RUs 1101 may, in some embodiments, be communicatively coupled to one or more Multi-Access/Mobile Edge Computing (“MEC”) devices, referred to sometimes herein simply as “MECs” 1107. For example, RU 1101-1 may be communicatively coupled to MEC 1107-1, RU 1101-M may be communicatively coupled to MEC 1107-M, DU 1103-1 may be communicatively coupled to MEC 1107-2, DU 1103-N may be communicatively coupled to MEC 1107-N, CU 1105 may be communicatively coupled to MEC 1107-3, and so on. MECs 1107 may include hardware resources (e.g., configurable or provisionable hardware resources) that may be configured to provide services and/or otherwise process traffic to and/or from UE 109, via a respective RU 1101.

For example, RU 1101-1 may route some traffic, from UE 109, to MEC 1107-1 instead of to a core network (e.g., via DU 1103 and CU 1105). MEC 1107-1 may process the traffic, perform one or more computations based on the received traffic, and may provide traffic to UE 109 via RU 1101-1. In this manner, ultra-low latency services may be provided to UE 109, as traffic does not need to traverse DU 1103, CU 1105, and an intervening backhaul network between DU network 1100 and the core network. In some embodiments, MEC 1107 may include, and/or may implement, some or all of the functionality described above with respect to SOS 101.

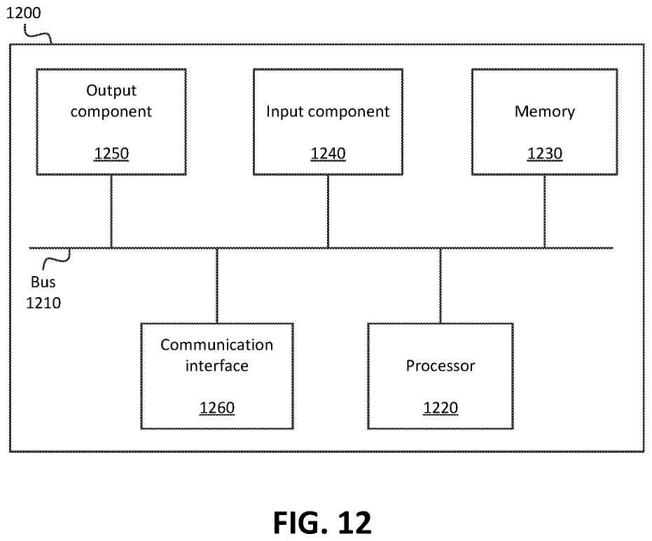

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, or processing logic that may interpret and execute instructions. In some embodiments, processor 1220 may be or may include one or more hardware processors. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200 and/or other receives or detects input from a source external to 1240, such as a touchpad, a touchscreen, a keyboard, a keypad, a button, a switch, a microphone or other audio input component, etc. In some embodiments, input component 1240 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems. For example, communication interface 1260 may include an Ethernet interface, an optical interface, a coaxial interface, or the like. Communication interface 1260 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1200 may include more than one communication interface 1260. For instance, device 1200 may include an optical interface and an Ethernet interface.

Device 1200 may perform certain operations relating to one or more processes described above. Device 1200 may perform these operations in response to processor 1220 executing software instructions stored in a computer-readable medium, such as memory 1230. A computer-readable medium may be defined as a non-transitory memory device. A memory device may include space within a single physical memory device or spread across multiple physical memory devices. The software instructions may be read into memory 1230 from another computer-readable medium or from another device. The software instructions stored in memory 1230 may cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-9) the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
generate or modify a set of models based on a set of Key Performance Indicators (“KPIs”), wherein a particular model of the set of models is associated with a particular set of KPIs with a set of corresponding values for each KPI of the particular set of KPIs;
receive a solution request that is associated with a set of KPI preferences;
identify, based on the solution request and the set of models, a first set of candidate solutions, wherein each candidate solution of the first set of candidate solutions is associated with a respective one or more models;
identify a second set of candidate solutions by filtering one or more candidate solutions, of the first set of candidate solutions, based on the set of KPI preferences; and
provide, in response to the solution request, at least one solution of the second set of candidate solutions.

2. The device of claim 1, wherein the first set of candidate solutions includes at least a first candidate solution and a second candidate solution, and wherein the second set of candidate solutions includes at least the first candidate solution and does not include the second candidate solution.

3. The device of claim 1, wherein identifying the second set of candidate solutions includes identifying a Pareto set of the first set of candidate solutions, wherein the Pareto set includes the second set of candidate solutions.

4. The device of claim 3, wherein the Pareto set is identified based on KPI scores associated with each model of the first set of candidate solutions.

5. The device of claim 1, wherein the one or more processors are further configured to:
identify one or more threshold KPI values based on the set of KPI preferences, wherein filtering the first set of candidate solutions to identify the second set of candidate solutions includes filtering candidate solutions, of the first set of candidate solutions, that do not satisfy the one or more threshold KPI values.

6. The device of claim 1, wherein the one or more processors are further configured to:
identify comparative KPI differences between candidate solutions of the second set of candidate solutions,
wherein providing the at least one solution includes providing at least two solutions of the second set of candidate solutions includes providing an indication of comparative KPI differences between the at least two solutions of the second set of candidate solutions.

7. The device of claim 1, wherein the solution request includes a navigation request with a starting point and a destination, and wherein the second set of candidate solutions includes a set of routes from the starting point to the destination.

8. A non-transitory computer-readable medium, storing a plurality of processor-executable instructions to:
generate or modify a set of models based on a set of Key Performance Indicators (“KPIs”), wherein a particular model of the set of models is associated with a particular set of KPIs with a set of corresponding values for each KPI of the particular set of KPIs;
receive a solution request that is associated with a set of KPI preferences;
identify, based on the solution request and the set of models, a first set of candidate solutions, wherein each candidate solution of the first set of candidate solutions is associated with a respective one or more models;
identify a second set of candidate solutions by filtering one or more candidate solutions, of the first set of candidate solutions, based on the set of KPI preferences; and
provide, in response to the solution request, at least one solution of the second set of candidate solutions.

9. The non-transitory computer-readable medium of claim 8, wherein the first set of candidate solutions includes at least a first candidate solution and a second candidate solution, and wherein the second set of candidate solutions includes at least the first candidate solution and does not include the second candidate solution.

10. The non-transitory computer-readable medium of claim 8, wherein identifying the second set of candidate solutions includes identifying a Pareto set of the first set of candidate solutions, wherein the Pareto set includes the second set of candidate solutions.

11. The non-transitory computer-readable medium of claim 10, wherein the Pareto set is identified based on KPI scores associated with each model of the first set of candidate solutions.

12. The non-transitory computer-readable medium of claim 8, wherein the plurality of processor-executable instructions further include processor-executable instructions to:
identify one or more threshold KPI values based on the set of KPI preferences, wherein filtering the first set of candidate solutions to identify the second set of candidate solutions includes filtering candidate solutions, of the first set of candidate solutions, that do not satisfy the one or more threshold KPI values.

13. The non-transitory computer-readable medium of claim 8, wherein the plurality of processor-executable instructions further include processor-executable instructions to:
identify comparative KPI differences between candidate solutions of the second set of candidate solutions,
wherein providing the at least one solution includes providing at least two solutions of the second set of candidate solutions includes providing an indication of comparative KPI differences between the at least two solutions of the second set of candidate solutions.

14. The non-transitory computer-readable medium of claim 8, wherein the solution request includes a navigation request with a starting point and a destination, and wherein the second set of candidate solutions includes a set of routes from the starting point to the destination.

15. A method, comprising:
generating or modifying a set of models based on a set of Key Performance Indicators (“KPIs”), wherein a particular model of the set of models is associated with a particular set of KPIs with a set of corresponding values for each KPI of the particular set of KPIs;
receiving a solution request that is associated with a set of KPI preferences;
identifying, based on the solution request and the set of models, a first set of candidate solutions, wherein each candidate solution of the first set of candidate solutions is associated with a respective one or more models;
identifying a second set of candidate solutions by filtering one or more candidate solutions, of the first set of candidate solutions, based on the set of KPI preferences; and
providing, in response to the solution request, at least one solution of the second set of candidate solutions.

16. The method of claim 15, wherein the first set of candidate solutions includes at least a first candidate solution and a second candidate solution, and wherein the second set of candidate solutions includes at least the first candidate solution and does not include the second candidate solution.

17. The method of claim 15, wherein identifying the second set of candidate solutions includes identifying, based on KPI scores associated with each model of the first set of candidate solutions, a Pareto set of the first set of candidate solutions, wherein the Pareto set includes the second set of candidate solutions.

18. The method of claim 15, further comprising:
identifying one or more threshold KPI values based on the set of KPI preferences, wherein filtering the first set of candidate solutions to identify the second set of candidate solutions includes filtering candidate solutions, of the first set of candidate solutions, that do not satisfy the one or more threshold KPI values.

19. The method of claim 15, further comprising:
identifying comparative KPI differences between candidate solutions of the second set of candidate solutions,
wherein providing the at least one solution includes providing at least two solutions of the second set of candidate solutions includes providing an indication of comparative KPI differences between the at least two solutions of the second set of candidate solutions.

20. The method of claim 15, wherein the solution request includes a navigation request with a starting point and a destination, and wherein the second set of candidate solutions includes a set of routes from the starting point to the destination.
